(19) United States
(12) Patent Application Publication
(10) Pub. No.: US 2026/0178920 A1
(43) Pub. Date: Jun. 25, 2026

(54) SYSTEM AND METHOD FOR PERFORMING ON-MANIFOLD DATA AUGMENTATION FOR DEEP LEARNING MODELS

(71) Applicant: JPMorgan Chase Bank, N.A., New York, NY (US)

(72) Inventors: Yousef EL-LAHAM, Brooklyn, NY (US); Elizabeth FONS, London (GB); Svitlana VYETRENKO, Berkeley, CA (US)

(73) Assignee: JPMorgan Chase Bank, N.A., New York, NY (US)

(21) Appl. No.: 18/989,648

(22) Filed: Dec. 20, 2024

(51) Int. Cl. G06N 3/09

(52) U.S. Cl. CPC G06N 3/09

(57) ABSTRACT

Various methods or systems for performing label-variant on-manifold data augmentation for training a deep learning (DL) model are disclosed. The present disclosure provides generating a first dataset, generating a weighted data graph based on the first dataset, generating a second dataset that is a neighboring dataset of the first dataset, in which the second dataset is generated based on the weighted data graph. The disclosure further provides generating a mixing ratio between the datasets, generating an interpolated embedding using the datasets, obtaining an interpolated prediction based on the interpolated embedding, evaluating a loss for generated interpolated prediction against an interpolation of ground truth labels, augmenting an expected value of the loss for the generated interpolated prediction, optimizing the augmented expected value of the loss to learn model parameters, and training the DL model using the learned model parameters for generating a modified embedding for constructing Mixup augmentations.

### TECHNICAL FIELD

This disclosure generally relates to performing on-manifold data augmentation for deep learning models.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Data augmentation techniques play a role in enhancing the performance of deep learning (DL) models in computer vision task. Data augmentation plays a role in improving the generalization of DL models for the computer vision tasks, especially in contexts where available training data may be scarce or imbalanced, whereby DL models may be more susceptible to overfitting. In this regard, data augmentation helps to implicitly regularize a DL model to capture underlying invariances in the data, which is an aspect of model generalization. In an example, a label of an image remains invariant across a variety of data transformations, such as rotations, cropping, grayscaling, translation and flipping. These transformations effectively expand the diversity of the training data, which in turn boosts the DL model's ability to generalize and improve its performance on out-of-sample data.

However, despite their proven benefits in computer vision task applications, data augmentation techniques remain limited in their application in other domains, in which a label is variant across data transformations unlike in computer vision tasks. Moreover, the manner in which data should be augmented remains an open question. Data augmentation techniques like Mixup, which augments samples to the data by creating linear combinations of existing data has shown to help improve generalization capabilities of deep neural networks for label-invariant transformations. However, for label variant transformations, such an operation may unintentionally create data samples that do not like on the manifold of the original data, and introduce a strong bias in the DL model being trained.

### SUMMARY

The present disclosure, through one or more of its various aspects, embodiments, and/or specific features or sub-components, provides, among other features, a method for performing label-variant on-manifold data augmentation for training a deep learning (DL) model is provided. The method includes performing, by a processor, a plurality of passes of an uniform manifold approximation and projection (UMAP) Mixup, in which each pass of the plurality of passes includes: generating a first dataset; generating a weighted data graph based on the first dataset; generating a second dataset that is a neighboring dataset of the first dataset, wherein the second dataset is generated based on the weighted data graph; generating a mixing ratio between the first dataset and the second dataset; generating an interpolated embedding using the first dataset and the second dataset; and obtaining an interpolated prediction based on the interpolated embedding, evaluating, via the processor, a loss for generated interpolated prediction against an interpolation of ground truth labels; augmenting, via the DL model executed by the processor, an expected value of the loss for the generated interpolated prediction with a UMAP loss; optimizing, via the DL model executed by the processor, the augmented expected value of the loss to learn model parameters; training, by the processor, the DL model using the learned model parameters for generating a modified embedding for constructing Mixup augmentations; and performing, via the DL model executed by the processor, a prediction for a third dataset.

In some embodiments, a supervised component of the UMAP loss is determined by mini-batching over at least one of the first dataset and the second dataset.

In some embodiments, the mini-batching includes creating mini-batches over edges of the weighted data graph.

In some embodiments, the creating of the mini-batches over the edges of the weighted data graph includes creating mini batches over positive and negative edges of the weighted data graph.

In some embodiments, the created mini-batches are mini-batched supervised loss that is defined over a set of data points that occur as vertices of the positive edges.

In some embodiments, the modified embedding preserves a structure of a dataset.

In some embodiments, the structure of data includes both local and global structures.

In some embodiments, at least one of the first dataset or the second dataset includes tabular data.

In some embodiments, at least one of the first dataset or the second dataset includes time-series data.

In some embodiments, the first dataset has an empirical distribution of data.

In some embodiments, the UMAP Mixup is an extension of a supervised parametric UMAP that constructs augmentations by applying Mixup to a parametric UMAP embedding.

In some embodiments, a system for performing label-variant on-manifold data augmentation for training a DL model is disclosed. The system may include: a processor; and a memory operatively connected to the processor via a communication interface, the memory storing computer readable instructions, when executed, causes the processor to execute: performing a plurality of passes of an UMAP Mixup, in which each pass of the plurality of passes includes: generating a first dataset; generating a weighted data graph based on the first dataset; generating a second dataset that is a neighboring dataset of the first dataset, in which the second dataset is generated based on the weighted data graph; generating a mixing ratio between the first dataset and the second dataset; generating an interpolated embedding using the first dataset and the second dataset; and obtaining an interpolated prediction based on the interpolated embedding, evaluating a loss for generated interpolated prediction against an interpolation of ground truth labels; augmenting, via the DL model, an expected value of the loss for the generated interpolated prediction with a UMAP loss; optimizing, via the DL model, the augmented expected value of the loss to learn model parameters; training the DL model using the learned model parameters for generating a modified embedding for constructing Mixup augmentations; and performing, via the DL model, a prediction for a third dataset.

In some embodiments, a non-transitory computer readable medium configured to store instructions for performing label-variant on-manifold data augmentation for training a DL model is disclosed. The instructions, when executed, may cause a processor to perform the following: performing a plurality of passes of an UMAP Mixup, in which each pass of the plurality of passes includes: generating a first dataset; generating a weighted data graph based on the first dataset; generating a second dataset that is a neighboring dataset of the first dataset, in which the second dataset is generated based on the weighted data graph; generating a mixing ratio between the first dataset and the second dataset; generating an interpolated embedding using the first dataset and the second dataset; and obtaining an interpolated prediction based on the interpolated embedding, evaluating a loss for generated interpolated prediction against an interpolation of ground truth labels; augmenting, via the DL model, an expected value of the loss for the generated interpolated prediction with a UMAP loss; optimizing, via the DL model, the augmented expected value of the loss to learn model parameters; training the DL model using the learned model parameters for generating a modified embedding for constructing Mixup augmentations; and performing, via the DL model, a prediction for a third dataset.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a uniform manifold approximation and projection (UMAP) Mixup system in accordance with an embodiment.

FIG. 2 illustrates a diagram of a network environment for implementing an UMAP Mixup system in accordance with an embodiment.

FIG. 3 illustrates a system configuration diagram for implementing an UMAP Mixup system in accordance with an embodiment.

FIG. 4 illustrates a method for performing UMAP Mixup operation in accordance with an embodiment.

FIG. 5 illustrates a method for performing an approximation of a supervised parametric UMAP loss function via mini-batching in accordance with an embodiment.

FIG. 6 illustrates label-variant transformations in accordance with an embodiment.

FIGS. 7A-7B illustrate comparative embeddings from Manifold Mixup and UMAP Mixup regularizations in accordance with an embodiment.

FIGS. 8A-8B illustrate tabular results of various regularization schemes in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Conventional Mixup data augmentation scheme train neural networks on randomly sampled convex combinations of training data. However, a major challenge to the conventional Mixup data augmentation scheme is its limitation to its use to practical data modalities, including, but not limited to tabular and time series data. More specifically, the conventional Mixup data augmentation scheme may not provide realistic training example, and may introduce bias to the neural network models that leads to worse performance than standard training. Accordingly, use of the conventional Mixup data augmentation scheme may reduce accuracy in the above noted practical data modalities.

In consideration of the above noted obstacles or technical limitations, a system and method for incorporating Mixup in deep neural network training that guarantees that generated Mixup augmentation lie on the data manifold to ensure that the training increases accuracy without introducing an artificial bias. More specifically, the system and method may hybridize manifold Mixup with uniform manifold approximation and projection (UMAP). As a result, certain practical data modalities, such as tabular datasets (e.g., regression task) and time series datasets (e.g., forecasting task), which may be subject to label-variant transformations, may improve generalization performance of the deep learning (DL) model more than the conventional data augmentation training.

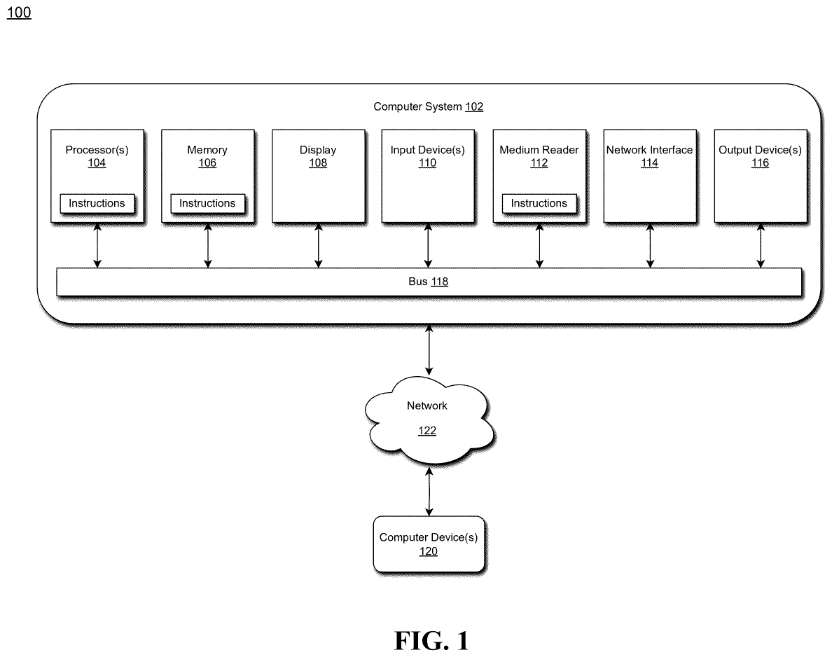

FIG. 1 is a system 100 for use in implementing a uniform manifold approximation and projection (UMAP) Mixup system in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the UMAP Mixup module implemented by the system 100 may allow for an UMAP Mixup module to ensure that the Mixup operations results in synthesized samples that lie on the data manifold of the features and labels by utilizing a dimensionality reduction technique known as UMAP.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

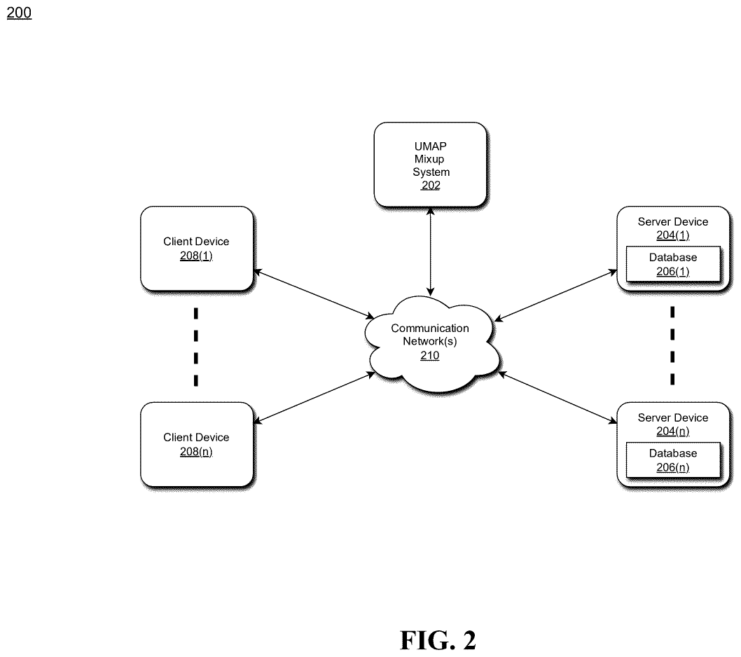

Referring to FIG. 2, a schematic of a network environment 200 for implementing an UMAP Mixup system is illustrated.

In some embodiments, the above-described problems associated with conventional data augmentation methods or frameworks for label-variant data transformations may be overcome by implementing a UMAP Mixup system 202 as illustrated in FIG. 2 that may be configured for implementing an UMAP Mixup module that ensures that the Mixup operations results in synthesized samples that lie on the data manifold of the features and labels by utilizing a dimensionality reduction technique known as UMAP.

The UMAP Mixup system 202 may include one or more computer system 102s, as described with respect to FIG. 1, which in aggregate provides the necessary functions.

The UMAP Mixup system 202 may store one or more applications that can include executable instructions that, when executed by the UMAP Mixup system 202, cause the UMAP Mixup system 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the UMAP Mixup system 202 itself, may be located in virtual server(s) running in a cloud-based computing environment rather than being tied to one or more specific physical network computing devices. Also, the application(s) may be running in one or more virtual machines (VMs) executing on the UMAP Mixup system 202. Additionally, in one or more embodiments of this technology, virtual machine(s) running on the UMAP Mixup system 202 may be managed or supervised by a hypervisor.

In the network environment 200 of FIG. 2, the UMAP Mixup system 202 may be coupled to a plurality of server devices 204(1)-204(n) that hosts a plurality of databases 206(1)-206(n), and also to a plurality of client devices 208(1)-208(n) via communication network(s) 210. A communication interface of the UMAP Mixup system 202, such as the network interface 114 of the computer system 102 of FIG. 1, operatively couples and communicates between the UMAP Mixup system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the UMAP Mixup system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The UMAP Mixup system 202 may be a standalone device or integrated with one or more other devices or apparatuses, such as one or more of the server devices 204(1)-204(n), for example. In one particular example, the UMAP Mixup system 202 may be hosted by one of the server devices 204(1)-204(n), and other arrangements are also possible. Moreover, one or more of the devices of the UMAP Mixup system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the UMAP Mixup system 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the UMAP Mixup system 202 that may efficiently provide a UMAP Mixup module configured for ensuring that the Mixup operations results in synthesized samples that lie on the data manifold of the features and labels by utilizing a dimensionality reduction technique known as UMAP.

The client devices 208(1)-208(n) may run interface applications, such as standard web browsers or standalone client applications, which may provide an interface to communicate with the UMAP Mixup system 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the UMAP Mixup system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the UMAP Mixup system 202, the server devices 204(1)-204(n), or the client devices 208(1)-208(n), for example, may be configured to operate as virtual instances on the same physical machine. For example, one or more of the UMAP Mixup system 202, the server devices 204(1)-204(n), or the client devices 208(1)-208(n) may operate on the same physical device rather than as separate devices communicating through communication network(s) 210. Additionally, there may be more or fewer UMAP Mixup system s 202, server devices 204(1)-204(n), or client devices 208(1)-208(n) than illustrated in FIG. 2. In some embodiments, the UMAP Mixup system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

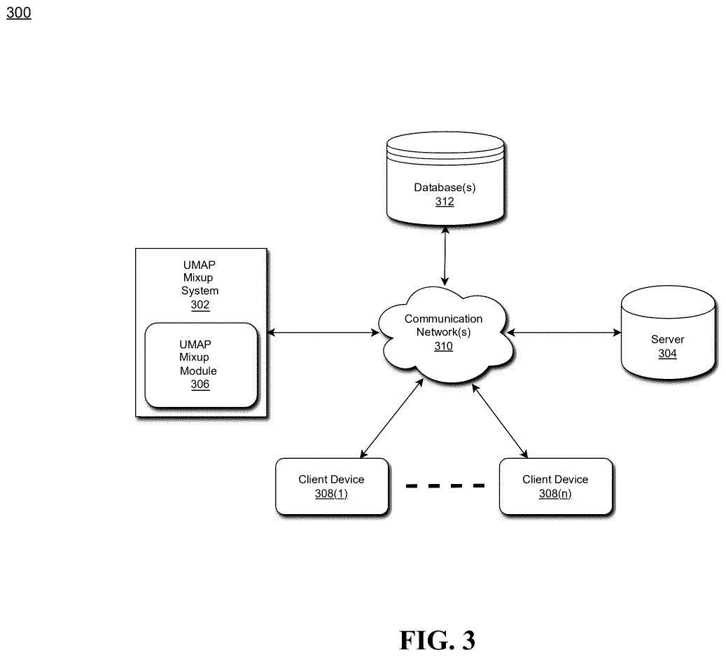

FIG. 3 illustrates a system diagram for implementing an UMAP Mixup system in accordance with an embodiment.

As illustrated in FIG. 3, the system 300 may include an UMAP Mixup system 302 within which an UMAP Mixup module 306 is embedded, a server 304, a database(s) 312, a plurality of client devices 308(1) . . . 308(n), and a communication network 310.

In some embodiments, the UMAP Mixup system 302 including the UMAP Mixup module 306 may be connected to the server 304, and the database(s) 312 via the communication network 310. The UMAP Mixup system 302 may also be connected to the plurality of client devices 308(1) . . . 308(n) via the communication network 310, but the disclosure is not limited thereto. The database(s) 312 may include one or more rule databases.

In an embodiment, the UMAP Mixup system 302 is described and shown in FIG. 3 as including the UMAP Mixup module 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the UMAP Mixup module 306 may be configured to receive real-time feed of data from the plurality of client devices 308(1) . . . 308(n) and secondary sources via the communication network 310.

The UMAP Mixup module 306 may be configured to execute: performing a plurality of passes of an UMAP Mixup, in which each pass of the plurality of passes includes: generating a first dataset; generating a weighted data graph based on the first dataset; generating a second dataset that is a neighboring dataset of the first dataset, in which the second dataset is generated based on the weighted data graph; generating a mixing ratio between the first dataset and the second dataset; generating an interpolated embedding using the first dataset and the second dataset; and obtaining an interpolated prediction based on the interpolated embedding, evaluating a loss for generated interpolated prediction against an interpolation of ground truth labels; augmenting, via the DL model, an expected value of the loss for the generated interpolated prediction with a UMAP loss; optimizing, via the DL model, the augmented expected value of the loss to learn model parameters; training the DL model using the learned model parameters for generating a modified embedding for constructing Mixup augmentations; and performing, via the DL model, a prediction for a third dataset, but the disclosure is not limited thereto.

The plurality of client devices 308(1) . . . 308(n) are illustrated as being in communication with the UMAP Mixup system 302. In this regard, the plurality of client devices 308(1) . . . 308(n) may be “clients” (e.g., customers) of the UMAP Mixup system 302 and are described herein as such. Nevertheless, it is to be known and understood that the plurality of client devices 308(1) . . . 308(n) need not necessarily be “clients” of the UMAP Mixup system 302, or any entity described in association therewith herein. Any additional or alternative relationship may exist between either or both of the plurality of client devices 308(1) . . . 308(n) and the UMAP Mixup system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the UMAP Mixup system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The UMAP Mixup system 302 may be the same or similar to the UMAP Mixup system 202 as described with respect to FIG. 2, including any features or combination of features described with respect thereto.

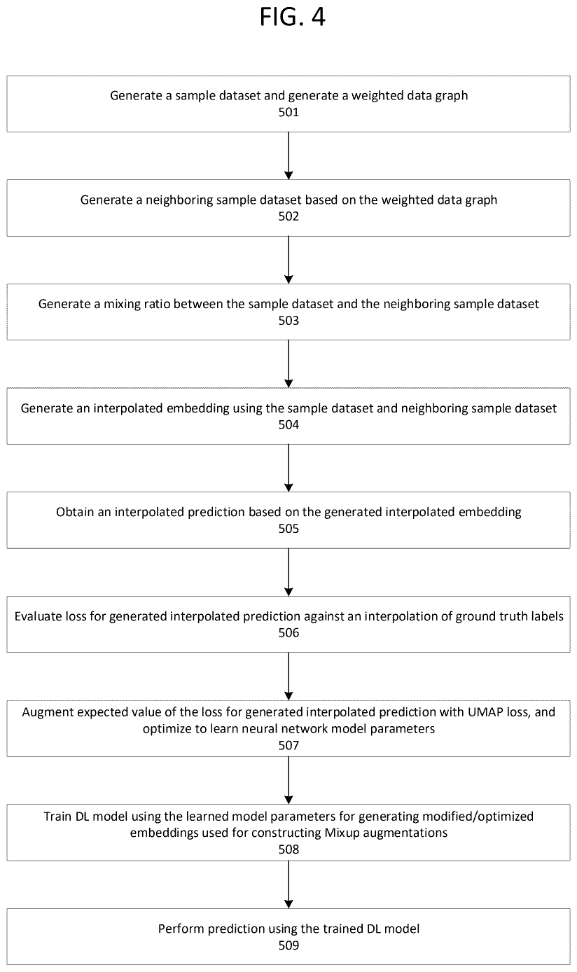

FIG. 4 illustrates a method for performing UMAP Mixup operation in accordance with an embodiment.

According to exemplary aspects, data augmentation may refer to a technique in machine learning where new data points are artificially created by making controlled modifications to existing data, essentially expanding a size and diversity of a dataset for improving training and generalization ability of a model, especially when dealing with limited data availability. In an example, augmented data does not have to be realistic to improve model performance, and may include soft labels (e.g., dog 0.6, cat 0.4) to allow a model to learn in-between scenarios.

One of the ways for augmenting data into the training set of a deep neural network model is to use Mixup. Generally, Mixup works by generating synthetic samples as convex combinations of two random samples during the training process. More specifically, the Mixup technique is directed to train with random convex combinations of training samples, rather than the original samples themselves. Mixup augmentations may be constructed as follows:

$${x}^{\sim} = λ {x}_{i} + ( 1 - λ ) {x}_{j}$$

$${y}^{\sim} = λ {y}_{i} + ( 1 - λ ) {y}_{j} ,$$

where (xᵢ,yᵢ) and (xⱼ,yⱼ) are independently sampled from the empirical distribution of the observed dataset, λ˜Beta(α,α), and α is a hyperparameter controlling the mixing of the samples.

Mixup has shown a significant boost in performance comparison to standard training, especially on larger computer vision datasets. At its core, Mixup can be seen as a vicinal risk minimization (VRM) technique that aims to regularize the learning algorithm by encouraging it to behave linearly in-between observed samples. This stands in contrast to empirical risk minimization (ERM), a principle of statistical learning theory that focuses on minimizing the loss over the empirical distribution of the training data. An extension in Mixup, referred to as Manifold Mixup, performs the Mixup operation in an intermediate layer of the deep learning model and in some cases can be shown to improve on the performance of the original Mixup algorithm. However, Manifold Mixup does not guarantee that augmentations are synthesized on a manifold with desired properties (e.g., preservation of both local and global structure). Accordingly, the synthetic training data may be off-manifold and may unintentionally create bias in the DL model trained with such training data, leading to diminished accuracy in predictive operations by the trained DL model.

However, it remains difficult to derive a comprehensive theoretical framework that guarantees that Mixup techniques will consistently improve the performance on out-of-sample, especially in contexts where the data may be subject to distribution shifts (e.g., label variant). Furthermore, for each Mixup technique, there is no way to guarantee that the mixing procedure of the features and labels will yield a synthesized sample that lies on the data manifold, such that the synthesized sample may potentially create bias and have an opposite effect of diminishing generalization capabilities of the DL model.

Generally, data augmentation generally includes projecting historical data using a dimensionality reduction technique, generating embeddings (e.g., random sampling, linear or nonlinear interpolations, etc.), and reconstructing data space representation of generated embeddings. In an example, dimensionality reduction techniques may include a principal component analysis (PCA) and UMAP. Moreover, an embedding may refer to a method of representing complex data, such as text, images or audio, as points in a continuous vector space, where the location of each point captures meaningful relationships between similar data points, allowing DL models or other machine learning models to identify and understand similarity between objects. In other words, embedding may refer to a way to translate real-world objects into numerical vectors that encode their key characteristics and relationships with other objects.

PCA may refer to a linear dimensionality reduction technique. In PCA, change of basis may be provided using principal components, and transformed data may still capture most of the variation of the original data. PCA may be utilized in generating yield rate curves.

UMAP, on the other hand, may refer to nonlinear dimensionality reduction technique. UMAP may be formulated from the lens of topology and category theory, and learned embedding preserves structures of data (e.g., local neighborhood).

According to further aspects, UMAP may refer to a nonlinear dimensionality reduction technique that aims to learn a lower-dimensional embedding of the data that preserves its topological structure. In an example, an advantage of UMAP in comparison to other dimensionality reduction techniques, such as T-SNE, is its ability to capture both local and global structure in the learned embeddings.

According to some aspects, (i) the data may be uniformly distributed on a Riemannian manifold; (ii) the Riemmanian metric is locally constant; and (iii) the manifold is locally connected, for the implementation of UMAP. Based on the above noted conditions for the implementations of UMAP, a set of embeddings

$${\{ {z}_{i} ∈ {ℝ}^{{d}_{s}} \}}_{i = 1}^{N}$$

may be optimized, where each zᵢ corresponds to the embedding of the data point xᵢ.

Generally, the UMAP procedure has two basic steps. First, a topological representation of the data is constructed using fuzzy simplicial sets, and second, the embeddings are optimized so that their topological representation has the closest fuzzy topological structure to that of the representation in data space.

According to some aspects, a simplicial set may refer to a mathematical object constructed from simplices (e.g., triangles, tetrahedra) in a specific way, essentially acting as a combinatorial model for a topological space. Formally, the simplicial set may be defined as a contravariant functor from the simplex category to the category of sets, allowing for the study of higher-dimensional structures by building them from basic building blocks like points, lines, triangles, etc.

According to some aspects, the fuzzy topological structure may refer to a mathematical framework that combines of traditional topology with fuzzy set theory, allowing for the representation of degrees of openness in a space, where elements may partially belong to a set rather than being strictly inside or outside, enabling analysis of vague or uncertain data within a topological space. In other words, the fuzzy topological structure may provide a way to describe the structure of a space where boundaries between open and closed sets may not always clearly defined, using membership functions to assign degrees of membership to each point within a set.

Computationally, the UMAP procedure amounts to minimizing the cross entropy between two graph representations: P (data graph) and Q (embedding graph). Nonparametric UMAP optimizes the embeddings directly, whereas parametric UMAP optimizes the parameters of some function approximator (e.g., a neural network) that outputs the embeddings. The present disclosure focuses on embeddings obtained from neural networks, and highlights the parametric UMAP procedure. According to example aspects, parametric UMAP may capture both local and global structure in the data.

The data graph P denotes a graphical representation, whose elements are denoted by p_{i,j}, is constructed by computing directional probabilities between each datapoint and its K-nearest neighbors given by (or symmetrizing a weighted nearest neighbors graph):

$${p}_{j \vert i} = exp ( \frac{- ( d ( {x}_{i} , {x}_{j} ) - {ρ}_{i} )}{{σ}_{i}} ) , {x}_{j} ∈ 𝒩 ( {x}_{i} )$$

where d(xᵢ,xⱼ) is a distance function, pᵢ and σᵢ are local connectivity parameters, and N(xᵢ) is the local neighborhood of xᵢ. The local connectivity parameters and the local neighborhood are determined by the K number of neighbors considered, which is a hyperparameter in the UMAP algorithm.

Once the directional probabilities p_{j|i} are determined, the probabilities are symmetrized as shown below:

$$pi , j = ( pj \vert i + pi \vert j ) - pj \vert ipi \vert j$$

Let zᵢ=h_{φ}(xᵢ) denote the embedding of data point xᵢ∈R^{dx} obtain from some parametric function h_{φ}:R^{dx}→R^{dz} with φ∈Φ. The embedding graph Q^{φ}, whose elements edges are denoted by q_{i,j}, is constructed by computing:

$$qi , j = ( 1 + a ‖ zi - zj ‖ 2 b ) - 1 ,$$

where a and b are hyperparameters that impact the minimum distance between the embeddings.

Given the data graph P, the UMAP algorithm optimizes the embeddings such that the corresponding embedding graph Q_{φ} is the one that minimizes the cross-entropy loss between P and Q_{φ}, which is defined as:

$$C ( P , {Q}_{ϕ} ) = {\sum }_{i \neq j} {p}_{i , j} log ( \frac{{p}_{i , j}}{{q}_{i , j}} ) + ( 1 - {p}_{i , j} ) log ( \frac{1 - {p}_{i , j}}{1 - {q}_{i , j}} )$$

In parametric UMAP, optimization of the above noted UMAP algorithm amounts to solving:

$${ϕ}_{b} = arg min C ( P , {Q}_{ϕ} ) , ϕ ∈ Φ$$

which can be accomplished using stochastic optimization.

According to example aspects, a novel variant of Mixup that joins manifold Mixup with parametric UMAP is provided as an UMAP Mixup framework. More specifically, the Mixup operation is applied in an intermediate layer of the classifier that is optimized to have similar topological structure to the original data using the UMAP loss as a regularizer. The UMAP Mixup framework aims to guarantee that the Mixup operation results in a synthesized sample that lies on the data manifold. This is accomplished by training an intermediate layer of the DL model to learn an embedding that exhibits this property, using a technique called UMAP. The UMAP technique may refer to a nonlinear dimensionality reduction method that optimizes embeddings to preserve the topological structure of the data. The UMAP Mixup framework incorporates an additional UMAP-based regularizer during training to optimize the learned embedding used for constructing the Mixup augmentations. The UMAP-based regularizer encourages the model to assign similar latent embeddings to the data points that are near each other in feature space according to a pre-defined distance metric, thereby promoting better on-manifold data augmentation.

More specifically, a supervised parametric UMAP is provided below. In this regard, the predictive model form is considered:

$$y = {f}_{θ} ( x ) = {g}_{θ 2} ( {h}_{θ 1} ( x ) ) ,$$

where h_{θ1}:R^{dx}→R^{dz} is a neural network mapping from features to a d_{z}-dimensional embedding and g_{θ2}:R^{dz}→Y is another neural network mapping the embeddings to predictions.

The parameters θ={θ₁,θ₂} are learned in a semi-supervised fashion using a loss [symbol] (ƒ_{θ}(x),y) (supervised loss) and the UMAP loss as defined in (9) (unsupervised loss). This is done by adding a regularizer to the risk:

$${R}_{reg} ( θ ; γ ) = E [ ℓ ( {f}_{{θ}_{}} ( x ) , y ) ] + γ C ( P , {Q}_{θ 1} ) .$$

where Q_{θ1} is the parametric UMAP embedding graph as determined by the neural network h_{θ1} and γ≥0 is a regularization parameter that controls the influence of the UMAP loss. The first term can be approximated using the empirical distribution of the data, just as it is done in ERM, while the second term can be approximated as by sampling edges of the data graph P.

Specifically, for a given dataset D, the supervised parametric UMAP loss function is given by:

$${\hat{R}}_{reg} ( θ ; γ ) = ( \frac{1}{N} {\sum }_{i = 1}^{N} {ℓ}_{θ} ( {f}_{{θ}_{}} ( {x}_{i} ) , {y}_{i} ) ) + γ C ( P , {Q}_{θ 1} )$$

In practice, the parameters θ₁ and θ₂ can be learned jointly using stochastic optimization algorithms, such as stochastic gradient descent or Adam. In particular, each term in the loss in the supervised parametric UMAP loss function is approximated by mini-batching, where the supervised component of the loss is approximated by mini-batching over the dataset D and the UMAP regularizer is approximated by mini-batching over the edges of the data graph P, as described in the above noted predictive model form and an interpolated embedding provided in operation 504 described in more detail below.

Generally, a goal of supervised learning is to learn a mapping of y=ƒ_{θ}(x) using some training dataset

$$D = {\{ ( {x}_{i} , {y}_{i} ) \}}_{i = 1}^{n} .$$

The usual approach may include a determination of empirical risk minimization (ERM), which may minimize the average training loss by the following:

$${\hat{θ}}_{ERM} = {argmin}_{θ ∈ Θ} \frac{1}{N} {\sum }_{i = 1}^{N} ℓ ( {f}_{{θ}_{}} ( {x}_{i} ) , {y}_{i} ) .$$

Mixup may refer to a data augmentation technique used to regularize a DL model by training on convex combinations of training samples. Assuming that (x, y) and (x′,y′) are two independent and identically distributed samples from a training dataset, Mixup augmentations may be constructed as follows:

$$λ ∼ Beta ( α , α )$$

$$\tilde{x} = λ x + ( 1 - λ ) {x}^{′}$$

$$\tilde{y} = λ y + ( 1 - λ ) {y}^{′}$$

Based on the above, parameters are learned to minimize the average loss across interpolated samples. Although Mixup data augmentation performs regularization to prevent overfitting and has shown to provide improve performance of DL models in large computer vision tasks (e.g., ImageNet classification), no such improvement has been able to be realized in label-invariant applications (e.g., times series data and tabular datasets). For example, is properties of data are known to be invariant to some defined transformations, such as class labels in computer vision tasks, data may be augment transformed into the DL model to improve generalization performance. More specifically, the class labels may be invariant to rotations, flipping, cropping, grayscale and the like.

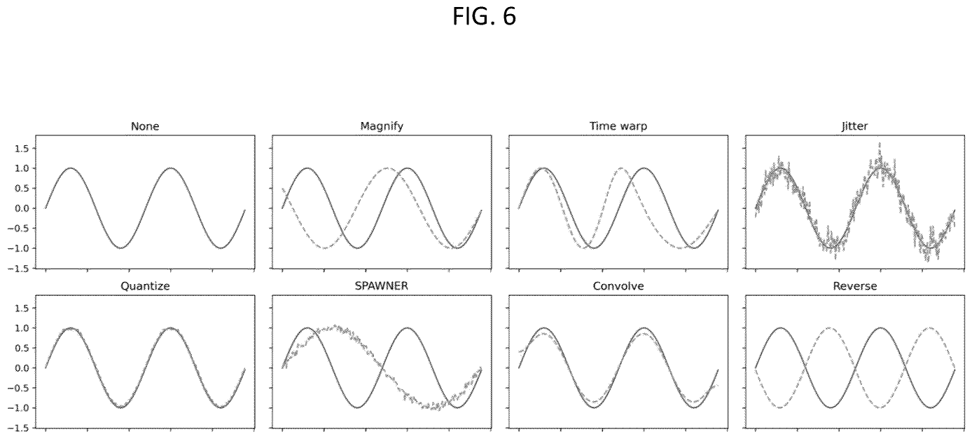

However, in time-series data, where class labels may be subject to change or are variant to augment transformations as illustrated in FIG. 6, the DL model may not be improved by the conventional data augmentation typically applied to the computer vision tasks. As illustrated in FIG. 6, under different augment transformations, labels or trends (e.g., magnify, time warp, jitter, quantize, spawner, convolve and reverse) of the time-series data may change. More specifically, augmentations constructed via Mixup may not lie on the underlying data manifold for label-variant properties. In fact, application of the conventional data augment transformations to the label-variant dataset may unintentionally introduce strong bias in the DL model and diminish generalization performance of the DL model.

In consideration the above noted drawbacks for applying Mixup data augmentations for data properties that are variant to data transformations, aspects of the present disclosure provides a system and method that ensures that Mixup operations result in synthesized samples that lie on the data manifold of the features and labels by utilizing a dimensionality reduction via UMAP Mixup.

According to example aspects, the UMAP Mixup method may refer to an extension of supervised parametric UMAP that constructs augmentations by applying Mixup to a parametric UMAP embedding. In UMAP Mixup, augmentations may be constructed in an intermediate layer of the DL model that is optimized to have target topological properties to ensure that the Mixup operations results in on-manifold augmentation. Further, a mini-batching scheme may be implemented for simultaneously optimizing the supervised loss and the UMAP embedding.

According to some aspects, UMAP may be directed to manifold learning technique for performing a nonlinear dimensionality reduction. Generally, UMAP may perform nonlinear dimensionality reduction by (1) constructing a topological representation of high-dimensional data, (2) constructing a topological representation of embeddings lying in lower dimensional space, and (3) optimizing low-dimensional embeddings so that the cross entropy between both topological representations is minimized.

During iterative training of the DL models, a single pass of the UMAP Mixup method or algorithm may be summarized in operations 501-505.

In operation 501, a sample dataset (x,y)˜D is generated, where D denotes the empirical distribution of the data, and a weighted data graph P is generated for the sample dataset. According to example aspects, a graphical representation of the sample dataset may be generated as a graph. In an example, the generated graph may serve as an approximate topological representation of the data and the embeddings. Based on the generated graph, deep learning may be performed to learn a set of weights that preserves a structure of the graph, both local and global structure.

According to example aspects, data graph may refer to a data structure represented as a graph, where information is organized into nodes (or vertices) connected by edges (or links), allowing for modeling of complex relationships and interactions between data points. This data structure may be useful for tasks, such as node classification, link prediction, and community detection within interconnected datasets. The weighted data graph may refer to a graph where each connection or edge between nodes is assigned a numerical value called weight, representing a corresponding strength or importance of that connection, allowing for more nuanced analysis of relationships within the data compared to an unweighted graph. In an example, the weights may signify factors like distance, influence or correlation based on the application.

In operation 502, a neighboring sample dataset (x′,y′) is generated based on the weighted data graph. In an example, neighboring dataset may refer to data points that are within a reference proximity to a given data point in a feature space, indicating that the neighboring data points have a certain level of similarity to the given data points. For example, the neighboring sample may be obtained via the K-Nearest Neighbors (KNN) algorithm, where a prediction for a new data point is made based on the labels of its nearest neighbors in the training dataset.

Although operation 501 and operation 502 are presented as two separate operations, aspects of the present disclosure are not limited thereto, such that the two operations may be summarized into a single step by sampling a random edge from the weighted data graph P.

In operation 503, a mixing ratio λ˜Beta(α,α) is generated. According to some aspects, the mixing ratio may refer to a proportion of different components within a dataset or multiple datasets, particularly when dealing with data that is a mixture of multiple sources or classes, where each component may represent a certain proportion of the overall data. In an example, the mixing ratio may signify a relative weight or distribution of each element within the combined dataset.

In operation 504, an interpolated embedding is generated using the sample dataset of operation 501 and the neighboring sample dataset of operation 502. The interpolated embedding may be generated based on an initial equation of z=h_{θ1}(x) and z′=h_{θ1}(x′). According to example aspects, the interpolated embedding is generated using the following:

$$\tilde{z} = λ z + ( 1 - λ ) {z}^{′} .$$

In an example, an embedding may refer to a method of representing complex data as points in a continuous vector space, where the location of each point captures meaningful relationships between similar data points, allowing DL models or other machine learning models to identify and understand similarity between objects. In other words, embedding may refer to a way to translate real-world objects into numerical vectors that encode their key characteristics and relationships with other objects. Moreover, interpolated embedding may refer to a new embedding vector created by mathematically combining (or interpolating) two or more existing embedding vectors. In other words, interpolated embedding may refer to generating a representation that lies somewhere between the original vectors in the embedding space for performing data augmentation or to explore relationships between data points within a dataset or datasets.

In operation 505, an interpolated prediction is obtained using the generated interpolated embedding. In an example, the interpolated prediction may be obtained as y^{˜}=g_{θ2}(z^{˜}). According to example aspects, interpolated prediction may refer to a prediction made by a model within the range of data it was trained on based on the interpolated embedding. In an example, interpolated prediction may estimate a value between known data points (on-manifold), rather than predicting values of that range to effectively fill in the gaps between existing data points based on the interpolated embedding or observed pattern.

In operation 506, a loss for the generated interpolated prediction is evaluated against an interpolation of the ground truth labels y and y′:

$${ℓ}_{θ}^{mix} ( x , {x}^{′} , y , {y}^{′} ) = {ℓ}_{θ} ( y , λ \tilde{y} + ( 1 - λ ) {y}^{′} )$$

In operation 507, the expected value of the loss of the interpolated prediction is augmented with the UMAP loss C(P,Q_{θ1}) and optimized in order to learn the model parameters using the following relationship:

$${θ}_{bUMAP}^{mix} = argmin E [ {ℓ}_{θ}^{mix} ( x , {x}^{′} , y , {y}^{′} ) ] + γ C ( P , {Q}_{θ 1} ) ,$$

$$θ ∈ Θ .$$

where α and γ are hyperparameters. According to some aspects, the hyperparameters may be selected using cross-validation, where the choices vary from dataset to dataset. For example, choices of α=2 and γ=0.1 may provide favorable results in practice for most datasets. In an example, UMAP loss may refer to a specific loss function used in UMAP algorithm or dimensionality reduction technique. The UMAP loss may measure how well the low-dimensional embedding of data preserves the relationship between data points in the original high-dimensional space using a cross-entropy loss function to penalize large discrepancies between the expected and actual distances in the low-dimensional representation.

Generally, in supervised learning, a function ƒ∈F that describes the relationship between a feature vector x∈R^{dx} and an output y∈R^{dy} is sought. In this regard, if x and y have a joint cumulative distribution function F(x,y), supervise learning will seek to find a function ƒ∈F that minimizes the risk: Z

$$R [ f ] = E [ ℓ ( f ( x ) , y ) ] = ℓ ( f ( x ) , y ) d F ( x , y ) ,$$

where [symbol] denotes a loss function used to measure the discrepancy between function output and the true output. In practice, it may be common to assume ƒ belongs to some parametric family of functions F_{θ} defined by parameters θ∈Θ. In this context, the following optimization problem may be sought to be solved:

$${θ}_{b} = arg min R ( θ ) ,$$

$$θ ∈ Θ$$

where R(θ)=E[ [symbol] (ƒ_{θ}(x),y)]. Unfortunately, F(x,y) is unknown and an approximations of the risk may be utilized to in order to solve the above noted optimization problem. In this regard, an ERM principle may typically be utilized, whereby parameters are learned by minimizing an approximation of the risk using the empirical distribution of an observed dataset

$$D = {\{ ( {x}_{i} , {y}_{i} ) \}}_{i = 1}^{N} : {θ}_{b} ERM = {argmin}_{θ ∈ Θ} \frac{1}{N} {\sum }_{i = 1}^{N} ℓ ( {f}_{{θ}_{}} ( {x}_{i} ) , {y}_{i} ) .$$

The ERM principle may result in a good parameter estimate if the dataset D accurately captures the true distribution F(x,y). However, this is not typically true in practice, and such that regularization techniques are often leveraged to help predictive models generalize better to out-of-sample data.

In operation 508, the DL model is trained using the learned model parameters for generating embeddings and performs a prediction. According to example aspects, the training of the DL model may include training an intermediate layer of the DL model to learn a modified or optimized embedding that guarantees that the Mixup augmentation results in a synthesized sample that lies on the data manifold.

In operation 509, a prediction may be performed for datasets subject to label-variant augmentations or transformations using the DL model. According to some aspects, at least since the optimized/modified embedding ensures that the Mixup augmentation results in providing a synthesized sample that lies on the data manifold, the DL model may improve its ability to perform generalizations without unintentional creation of bias via overfitting.

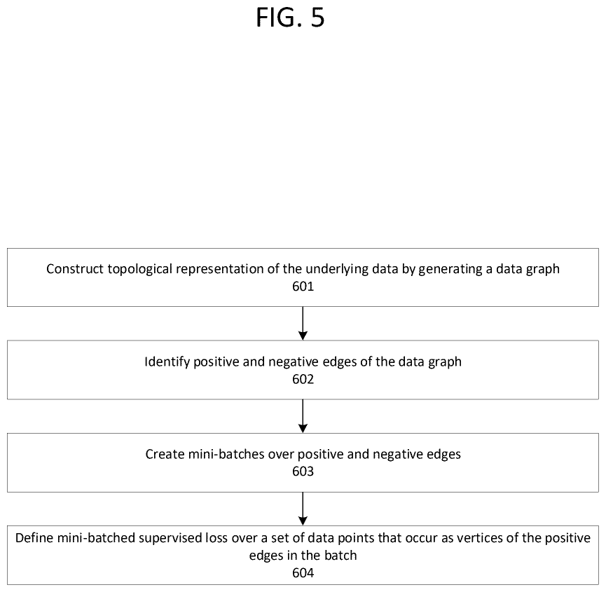

FIG. 5 illustrates a method for generating mini-batches of training epochs for UMAP Mixup in accordance with an embodiment.

In operation 601, topological representation of underlying data is constructed as a data graph P. Once the data graph P is generated in operation 601, positive and negative edges of the data graph are identified in operation 602.

Typical practice for creating batches consists of randomly shuffling training dataset in each epoch and iterating over subsets, which in effect performs sampling without replacement. However, cross entropy criterion in UMAP is defined over the set of edges of the data graph P. In contrast to the typical practice, operation 603 includes creating mini-batches over positive (p_{i,j}>0) and negative (p_{i,j}=0) edges of the data graph P, with the vertices that make up the batched positive edges then comprising the minibatch for the supervised loss. According to example aspects, supervised loss may refer to a function used to quantify the difference between a model's predictions and the known correct values (labels) in a supervised learning setting, essentially measuring how the model is performing on a given data point compared to the ground truth or reference values provided in the labeled training data. A goal for the supervised loss may be to minimize loss function during training to improve a model's accuracy.

According to further aspects, E⁺={e_{i,j}=(i,j)} may be the set of positive edges in a training epoch, where each edge e_{i,j} is included in E⁺ with probability p_{i,j}. For each positive edge e_{i,j}, M negative edges {e_{i,j1}, . . . , e_{i,jM}} may be associated by sampling j₁, . . . , j_{M} uniformly from the dataset, giving the set of negative edges in a training epoch E⁻={e_{i,j1}, . . . , e_{i,jM}: e_{i,j}∈E⁺}. Each training epoch of UMAP Mixup therefore may include iterating over subsets

$${E}_{b} = {E}_{b}^{+} ⋃ {E}_{b}^{-} , where {E}_{b}^{+} ⊂ {E}^{+} , {E}_{b}^{-} ⊂ {E}^{-} .$$

This provides a batch UMAP loss of:

$$C ( P , {Q}_{θ 1} ) \approx {C}_{b} ( P , {Q}_{θ 1} , {E}_{b} ) = \frac{1}{\vert {E}_{b} \vert} ( {\sum }_{\text{?}} log ( \frac{\text{?}}{\text{?}} ) + {\sum }_{\text{?}} log ( \frac{1 - {p}_{k , 1}}{1 - {p}_{k , 1}} ) ) .$$

$$\text{?} \text{indicates text missing or illegible when filed}$$

In operation 604, the mini-batched supervised loss is then defined over the set of data points that occur as vertices of the positive edges in the batch:

$$E [ {ℓ}_{θ}^{mix} ( x , {x}^{′} , y , {y}^{′} ) ] \approx Eb [ {ℓ}_{θ}^{mix} ( x , {x}^{′} , y , {y}^{′} ) ] = \frac{1}{\vert {E}_{b}^{+} \vert} {\sum }_{\text{?}} {ℓ}_{θ}^{mix} ( {x}_{i} , {x}_{j} , {y}_{i} , {y}_{j} ) .$$

$$\text{?} \text{indicates text missing or illegible when filed}$$

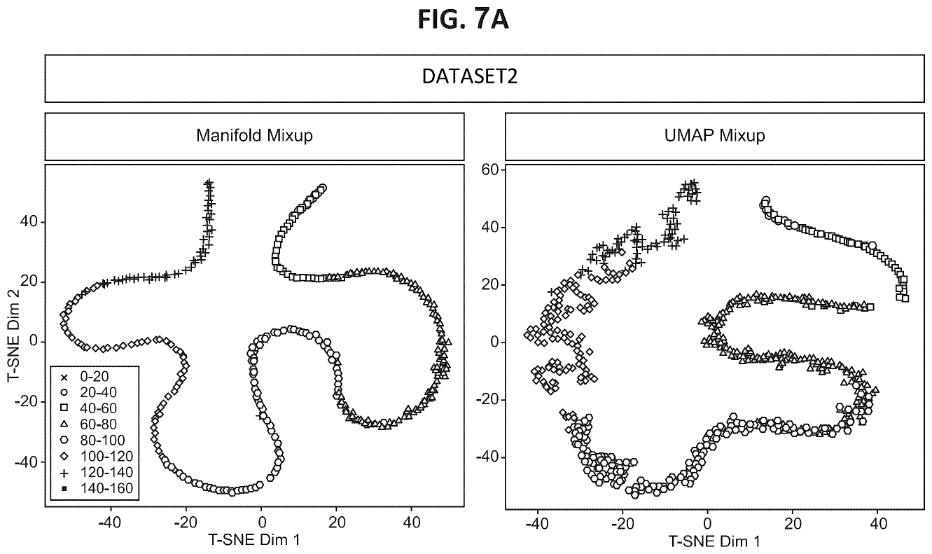

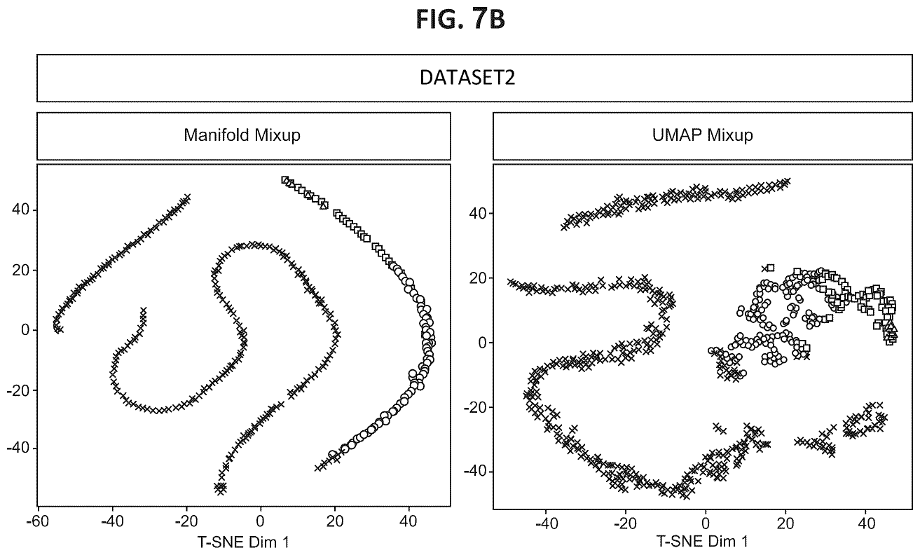

FIGS. 7A-7B illustrate comparative embeddings from Manifold Mixup and UMAP Mixup regularizations in accordance with an embodiment.

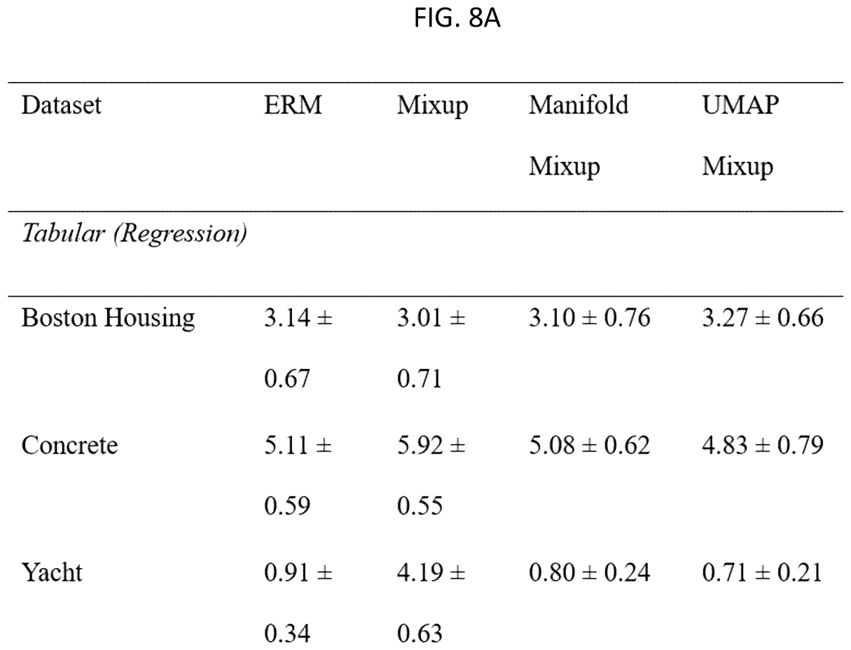

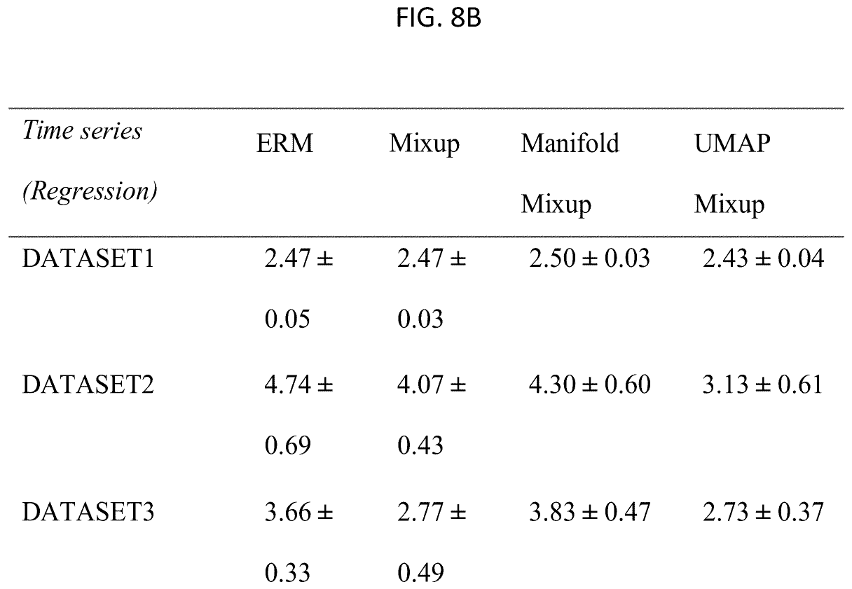

FIGS. 8A-8B illustrate tabular results of various regularization schemes in accordance with an embodiment.

As illustrated in FIGS. 7A-7B and FIGS. 8A-8B, UMAP Mixup's performance on regression tasks covering two different data modalities (tabular data and time series data) is validated. Further, evaluations across diverse regression tasks show that UMAP Mixup is competitive with or outperforms other Mixup variants, show promise for its potential as an effective tool for enhancing the generalization performance of DL models. All of the numerical results are summarized in FIGS. 8A-8B, which measures performance using root-mean squared error (RMSE).

FIGS. 7A-7B provides a visual comparison of resulting embeddings from both Manifold Mixup and UMAP Mixup regularizations on the company B and company C datasets. Visualizations are obtained by applying T-SNE to the extracted features just before the output layer of each neural network. Underlying data for FIGS. 7A-7B are provided in the tabular data in FIG. 8B.

For the generation of the information provided in FIG. 8A, performance of UMAP Mixup on a set of UCI regression benchmark datasets, including (a) Boston Housing dataset, (b) Concrete compressive strength dataset, and (c) Yacht hydrodynamics dataset. Experimental setup indicated in C(P,Q_{θ1})≈C_{b}(P,Q_{θ1},E_{b}) provided above was used, with each dataset split into 20 train-test folds. For each method, a (100, 50) 2-layer feedforward neural network was utilized. Each method was then trained using an optimizer, where learning rates and batch sizes according to values used in the batch UMAP loss equation provided above. For each baseline, cross-validation is used to select all hyperparameters. As shown in FIG. 8A, tabular results indicate that for the Concrete and Yacht datasets, UMAP Mixup is able to obtain significant reduction in RMSE as compared to the baselines.

For the time series data, the task of one-step-ahead forecasting for financial time series is in focus. Historical daily price data and an experimental setup indicated in C(P,Q_{θ1})≈C_{b}(P,Q_{θ1},E_{b}) provided above was used using a long short-term memory (LSTM) network, which is a type of recurrent neural network. The input to the LSTM corresponds to the closing price of a particular stock over the past 60 trading days and the target output is the next trading day's closing price. Each method was evaluated on three different datasets, namely Dataset1, Dataset2, and Dataset3. More specifically, training data from Dataset1 for company A from period of January 2015 to July 2022 (stable market regime) was used to test on company A stock data from the period of August 2022 to September 2023. Further, training data from the Dataset2 for company B from the period of January 2015 to June 202 (market shock regime) was used to test on company B stock data from the period of July 2020 to September 2023. This choice of dataset is motivated by the COVID shock that heavily affected the company B stock when the global pandemic caused widespread closures in the spring of 2020. Lastly, training data from Dataset3 for company C stock from the short squeeze period of January 2015 to January 2022 (high volatility regime) was used to test on company C stock following that period.

As shown in FIG. 8B, the UMAP Mixup regularization outperforms all baselines or other conventional regularization schemes. In particular, Manifold Mixup shows worst performance than the other methods, indicating that interpolation in the embedding space without further regularization does not necessarily improve generalization. FIGS. 7A-7B show a qualitative comparison of the embeddings of Manifold Mixup and our method, Manifold UMAP for the company B and company C datasets by using T-SNE to project the extracted features on the last hidden layer of each neural network. Based on the illustrations in FIGS. 7A-7B, it may be observed that Manifold Mixup shows a very compact embedding whilst the UMAP Mixup embeddings show more variability and therefore, interpolation between them would yield more diverse samples. This is particularly relevant in these datasets that suffer from distributional shifts such as a market shock regime in the case of company B due to COVID, and the high volatility regime of company C during the bubble period in early 2021.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing label-variant on-manifold data augmentation for training a deep learning (DL) model, the method comprising:
performing, by a processor, a plurality of passes of a uniform manifold approximation and projection (UMAP) Mixup, wherein each pass of the plurality of passes includes:
generating a first dataset;
generating a weighted data graph based on the first dataset;
generating a second dataset that is a neighboring dataset of the first dataset, wherein the second dataset is generated based on the weighted data graph;
generating a mixing ratio between the first dataset and the second dataset;
generating an interpolated embedding using the first dataset and the second dataset; and
obtaining an interpolated prediction based on the interpolated embedding,
evaluating, via the processor, a loss for generated interpolated prediction against an interpolation of ground truth labels;
augmenting, via the DL model executed by the processor, an expected value of the loss for the generated interpolated prediction with a UMAP loss;
optimizing, via the DL model executed by the processor, the augmented expected value of the loss to learn model parameters;
training, by the processor, the DL model using the learned model parameters for generating a modified embedding for constructing Mixup augmentations; and
performing, via the DL model executed by the processor, a prediction for a third dataset.

2. The method according to claim, wherein a supervised component of the UMAP loss is determined by mini-batching over at least one of the first dataset and the second dataset.

3. The method according to claim 2, wherein the mini-batching includes creating mini-batches over edges of the weighted data graph.

4. The method according to claim 3, wherein the creating of the mini-batches over the edges of the weighted data graph includes creating mini batches over positive and negative edges of the weighted data graph.

5. The method according to claim 4, wherein the created mini-batches are mini-batched supervised loss that is defined over a set of data points that occur as vertices of the positive edges.

6. The method according to claim 1, wherein the modified embedding preserves a structure of a dataset.

7. The method according to claim 6, wherein the structure of data includes both local and global structures.

8. The method according to claim 1, wherein at least one of the first dataset or the second dataset includes tabular data.

9. The method according to claim 1, wherein at least one of the first dataset or the second dataset includes time-series data.

10. The method according to claim 1, wherein the first dataset has an empirical distribution of data.

11. The method according to claim 1, wherein the UMAP Mixup is an extension of a supervised parametric UMAP that constructs augmentations by applying Mixup to a parametric UMAP embedding.

12. A system for performing label-variant on-manifold data augmentation for training a deep learning (DL) model, the system comprising:
a processor; and
a memory operatively connected to the processor via a communication interface, the memory storing computer readable instructions, when executed, causes the processor to execute:
performing a plurality of passes of a uniform manifold approximation and projection (UMAP) Mixup, wherein each pass of the plurality of passes includes:
generating a first dataset;
generating a weighted data graph based on the first dataset;
generating a second dataset that is a neighboring dataset of the first dataset, wherein the second dataset is generated based on the weighted data graph;
generating a mixing ratio between the first dataset and the second dataset;
generating an interpolated embedding using the first dataset and the second dataset; and
obtaining an interpolated prediction based on the interpolated embedding, evaluating a loss for generated interpolated prediction against an interpolation of ground truth labels;
augmenting, via the DL model, an expected value of the loss for the generated interpolated prediction with a UMAP loss;
optimizing, via the DL model, the augmented expected value of the loss to learn model parameters;
training the DL model using the learned model parameters for generating a modified embedding for constructing Mixup augmentations; and
performing, via the DL model, a prediction for a third dataset.

13. The system according to claim 12, wherein a supervised component of the UMAP loss is determined by mini-batching over at least one of the first dataset and the second dataset.

14. The system according to claim 13, wherein the mini-batching includes creating mini-batches over edges of the weighted data graph.

15. The system according to claim 14, wherein the creating of the mini-batches over the edges of the weighted data graph includes creating mini batches over positive and negative edges of the weighted data graph.

16. The system according to claim 15, wherein the created mini-batches are mini-batched supervised loss that is defined over a set of data points that occur as vertices of the positive edges.

17. The system according to claim 12, wherein the modified embedding preserves a structure of a dataset.

18. The system according to claim 17, wherein the structure of data includes both local and global structures.

19. The system according to claim 12, wherein at least one of the first dataset or the second dataset includes tabular data or time-series data.

20. A non-transitory computer readable medium configured to store instructions for performing label-variant on-manifold data augmentation for training a deep learning (DL) model, the instructions, when executed, cause a processor to perform the following:
performing a plurality of passes of a uniform manifold approximation and projection (UMAP) Mixup, wherein each pass of the plurality of passes includes:
generating a first dataset;
generating a weighted data graph based on the first dataset;
generating a second dataset that is a neighboring dataset of the first dataset, wherein the second dataset is generated based on the weighted data graph;
generating a mixing ratio between the first dataset and the second dataset;
generating an interpolated embedding using the first dataset and the second dataset; and
obtaining an interpolated prediction based on the interpolated embedding,
evaluating a loss for generated interpolated prediction against an interpolation of ground truth labels;
augmenting, via the DL model, an expected value of the loss for the generated interpolated prediction with a UMAP loss;
optimizing, via the DL model, the augmented expected value of the loss to learn model parameters;
training the DL model using the learned model parameters for generating a modified embedding for constructing Mixup augmentations; and
performing, via the DL model, a prediction for a third dataset.
